(19) United States
(12) Patent Application Publication
(10) Pub. No.: US 2009/0193799 A1
(43) Pub. Date: Aug. 6, 2009

(54) Hydraulic gravity harvester

(76) Inventor: Curtis R. LeBlanc, Thibodaux, LA (US)

Correspondence Address: Curtis R. LeBlanc, 153 Chisholm Trail, Thibodaux, LA, 70301, US

(21) Appl. No.: 12/321,526

(22) Filed: Jan. 22, 2009

Related U.S. Application Data
(60) Provisional application No. 61/011,829, filed on Jan. 22, 2008.

(51) Int. Cl. F03G 7/04; F03B 17/04

(52) U.S. Cl. 60/325; 60/327; 415/916

(57) ABSTRACT

A Hydraulic Gravity Harvester is disclosed; having a plural of slip buckets, each slip bucket has a piston that works with a valve that is connected to the lower end of each piston; each slip bucket reciprocates vertically within a cylinder. When the valve is in the closed position and the slip bucket is on the down stroke, it creates a positive pressure in the cylinder pushing fluid up to a reservoir positioned high above the slip buckets. Each slip bucket on the down stroke is connected so that the opposite valve is in the open position and on the up stroke, so the weight of the fluid that has pushed this slip bucket down now rest on the bottom of the cylinder. This allows the slip bucket that is on the down stroke to turn a shaft creating a rotational torque.

### CROSS REFERENCE AND PRIORITY CLAIM TO RELATED APPLICATIONS

This non-provisional patent application claims priority to, and the full benefit of, provisional patent application entitled “Hydraulic Gravity Harvester”, filed on Jan. 22, 2008, having assigned Ser. No. 61/011,829 and Foreign Filing License Granted on Feb. 6, 2008.

### STATEMENT REGARDING FEDERALLY SPONSORED RESEARCH OF DEVELOPMENT

Not Applicable

### DESCRIPTION OF ATTACHED APPENDIX

Not Applicable

### BACKGROUND OF THE INVENTION

The present invention relates generally to a gravity driven hydraulic energy generating machine, and more specifically to a Hydraulic Gravity Harvester and method for manipulating the difference between the weighed measured of a fluid medium and the hydrostatic pressure of a fluid column.

As concerns about the world's dependence on non-renewable energy sources increase, and people become more aware of the environmental impacts of fossil fuels, there is more interest in alternative energy sources. When designing alternative energy sources we must take extra care, as to not change the environment such as in the case of a hydroelectric dam, or produce long term hazardous waste such as in nuclear energy. Therefore, it is desirable to be able to produce energy without outside dependencies, environmental impacts, or hazardous waste.

Various devices and methods have been developed that utilize natural forces to provide energy. Many patents are not practical due to their cumbersome size, loss in fluids, uncontrollable weather conditions, such as cloudy/rainy days, flooding and drought, high and/or no winds and uncontrollable temperatures.

There are many patents that use both buoyancy and gravity that have valve systems which are very complicated and wood need a lot of maintenance due to wear and tear. These systems also use a lot of the energy that is produced to operate its own mechanics.

Patents that require the use of elaborate and complicated mechanisms are prone to mechanical failure and excessive wear of parts, raising maintenance costs.

The continuous use of assistance through external power sources to maintain a constant production of energy is also used by several other patent designs.

Therefore, it is very apparent that there is a great need for an energy producing system that is cost effective and can efficiently produce clean efficient self reliant energy. My present invention overcomes these previous problems to produce clean efficient residual energy.

### BRIEF SUMMARY OF THE INVENTION

The primary object of the invention is to provide a method for harvesting energy from gravity.

Another object of the invention is to provide a pump that operates on gravity alone.

A further object of the invention is to provide a pump that efficiently pumps higher than its location.

Another object of the invention is to provide a pump that operates with 100% displacement.

A further object of the invention is to convert gravity into rotational torque with a pump.

Yet another object of the invention is to convert rotational torque into energy.

A further object of the invention is to convert inertia into energy.

A further object of the invention is to provide a means to produce energy from a collective hydrostatic head.

Other objects and advantages of the present invention will become apparent from the following descriptions, taken in connection with the accompanying drawings, wherein, by way of illustration and example, an embodiment of the present invention is disclosed.

In accordance with the preferred embodiment of the invention, there is disclosed a Hydraulic Gravity Harvester comprising: a plural of slip bucket assemblies, a main drive chain assembly or cable for connecting a operator wheel affixed to the top of each slip bucket assembly to form a pair, a flywheel transmission assembly that connects to a main drive sprocket that is turned by the main drive chain assembly connected to each slip bucket assembly, a plural of fill up valve assemblies to control the fluid that operates the slip bucket assemblies, and a plural of check valves to control the backflow of excess fluid head.

### BRIEF DESCRIPTION OF THE INVENTION

The drawings constitute a part of this specification and include exemplary embodiments to the invention, which may be embodied in various forms. It is to be understood that in some instances various aspects of the invention may be shown exaggerated or enlarged to facilitate an understanding of the invention.

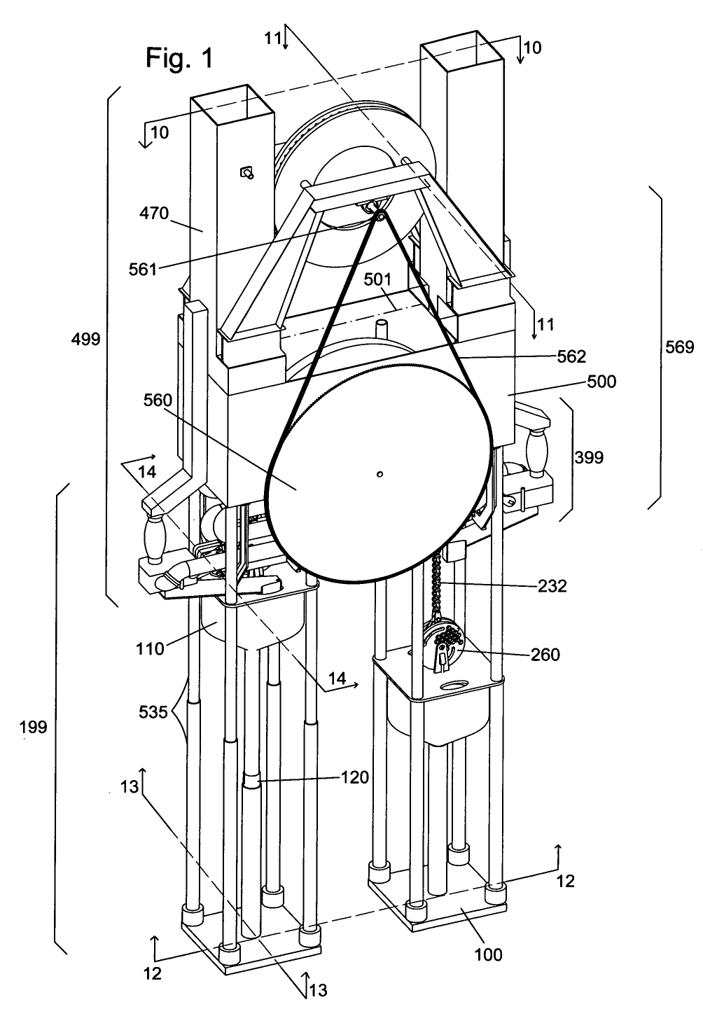

FIG. 1 shows a perspective view of a Hydraulic Gravity Harvester further showing cutaway views and general components of the invention.

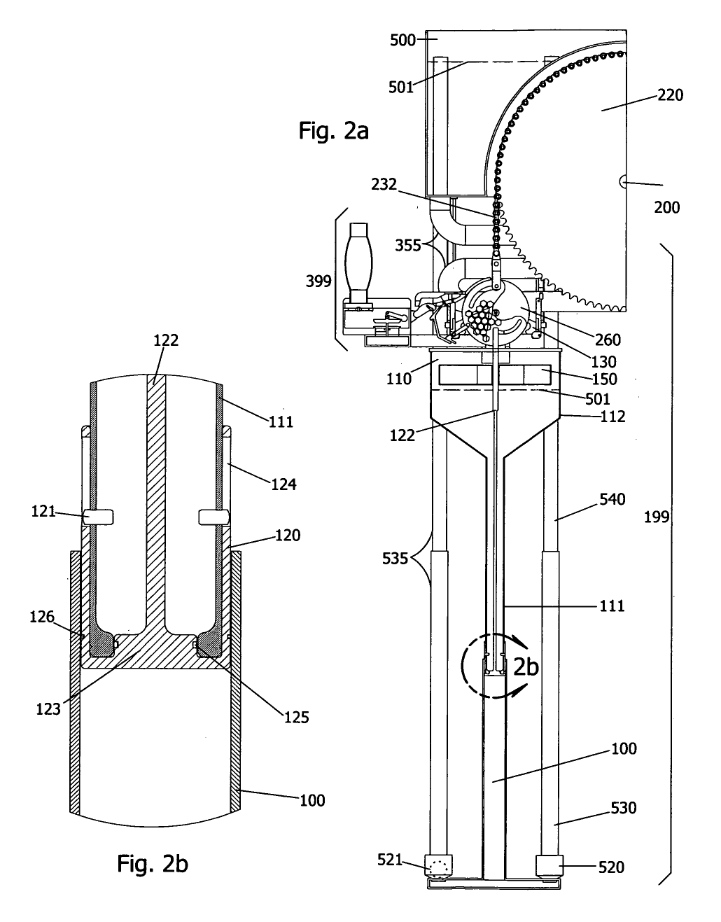

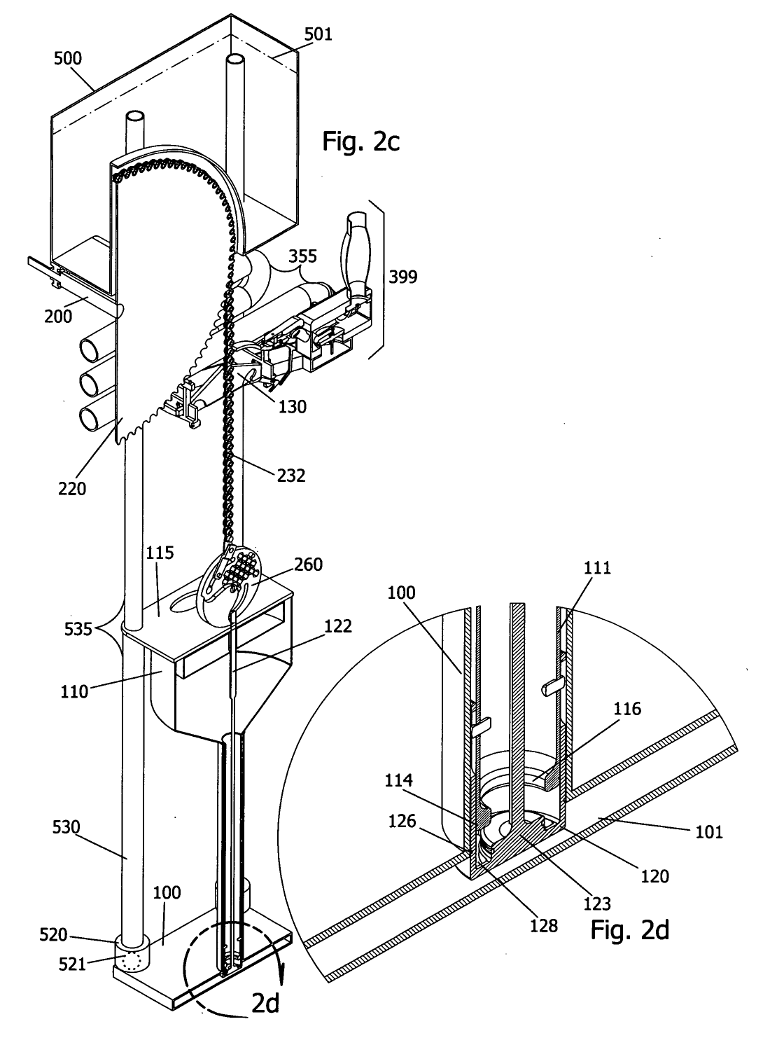

FIGS. 2a & 2b show a left front cutaway view showing inner components and one stage of a continuous slip bucket cycle.

FIGS. 2c & 2d show a perspective right front cutaway view showing inner components and the opposite stage of the slip bucket cycle shown in FIGS. 2a & 2b.

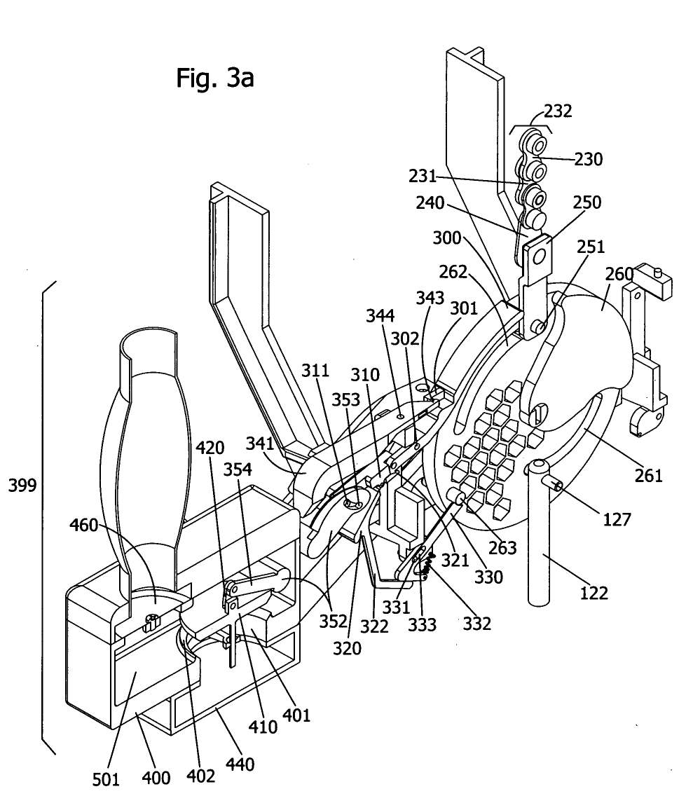

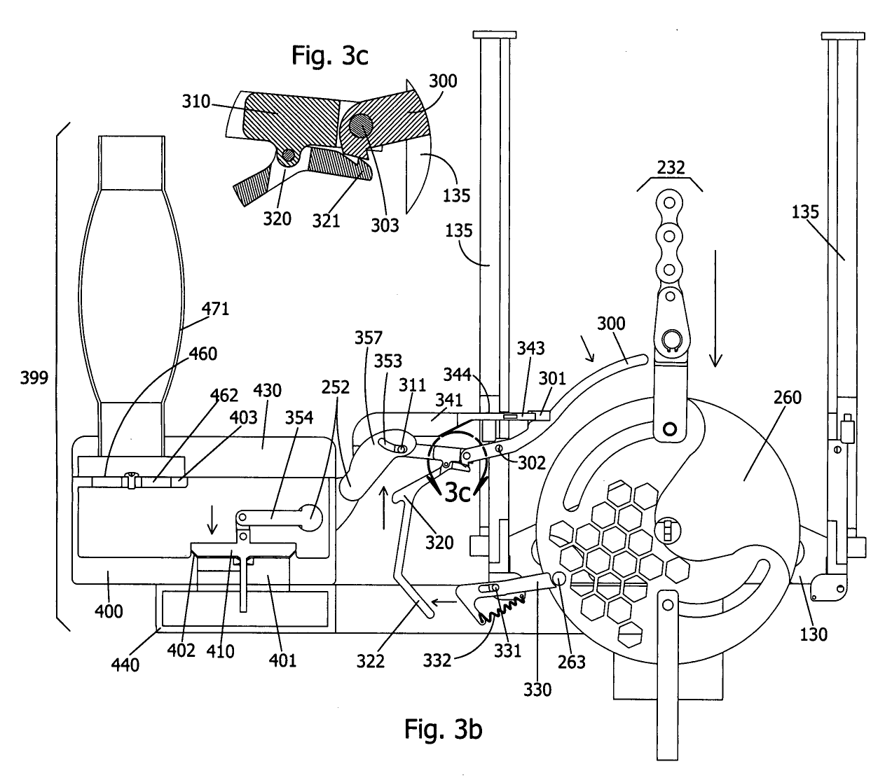

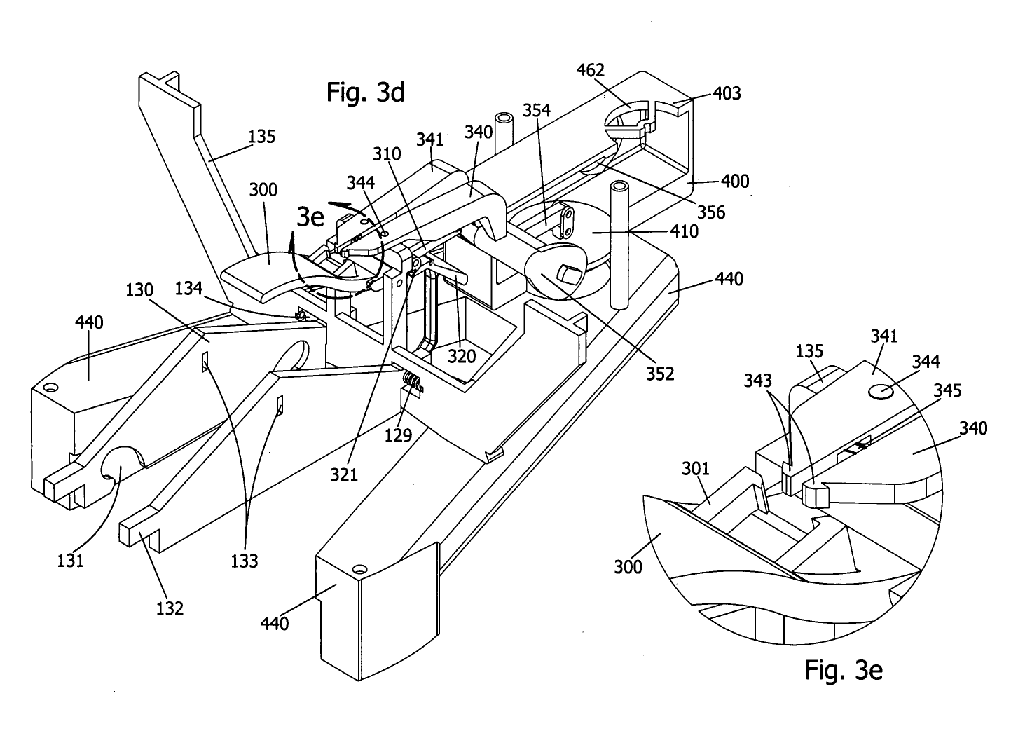

FIG. 3a shows a perspective cutaway view of the fill up valve assembly in the open fill up stage of the slip bucket cycle.

FIGS. 3b & 3c show a more detailed front cutaway view of the fill up valve assembly in its valve release stage of the slip bucket cycle.

FIGS. 3d & 3e show a perspective cutaway view of the fill up valve assembly in the closed ram stage.

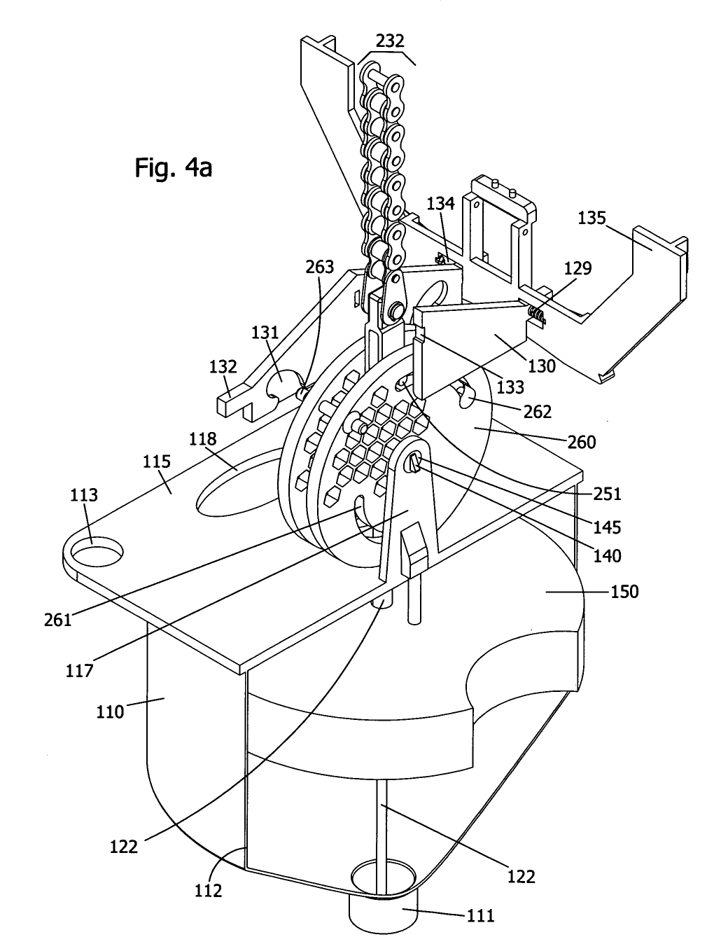

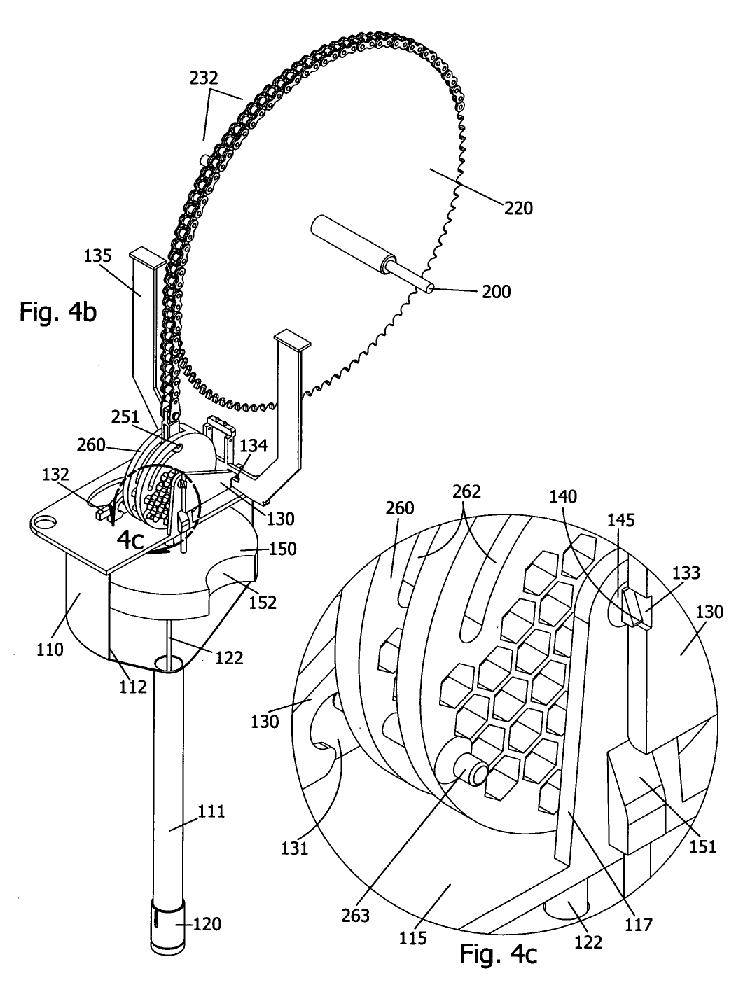

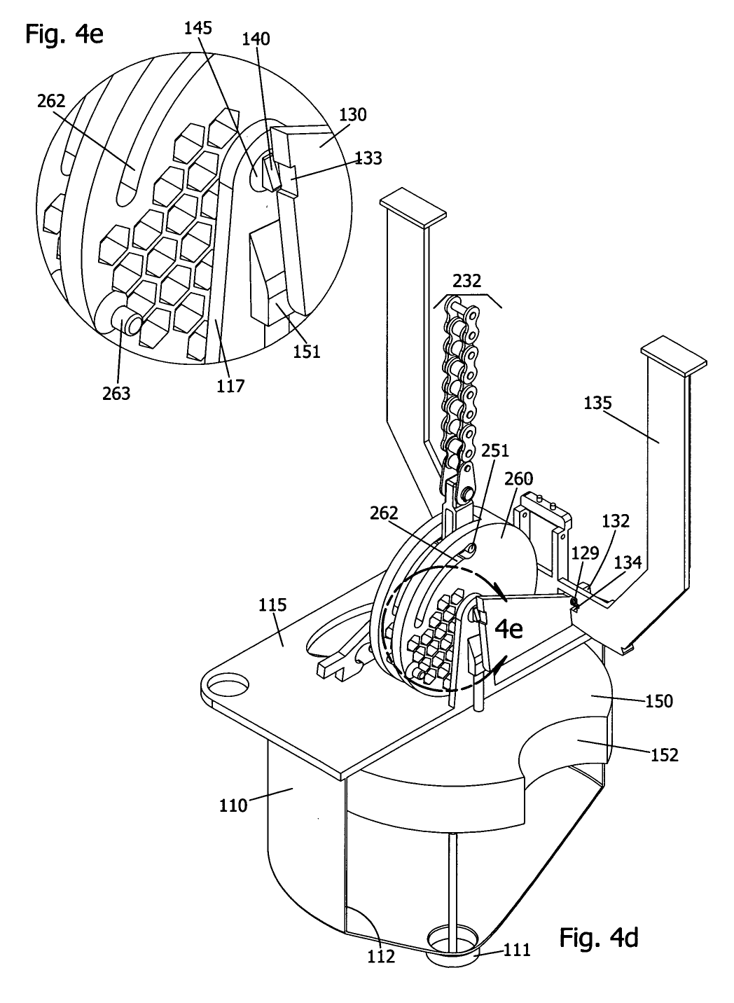

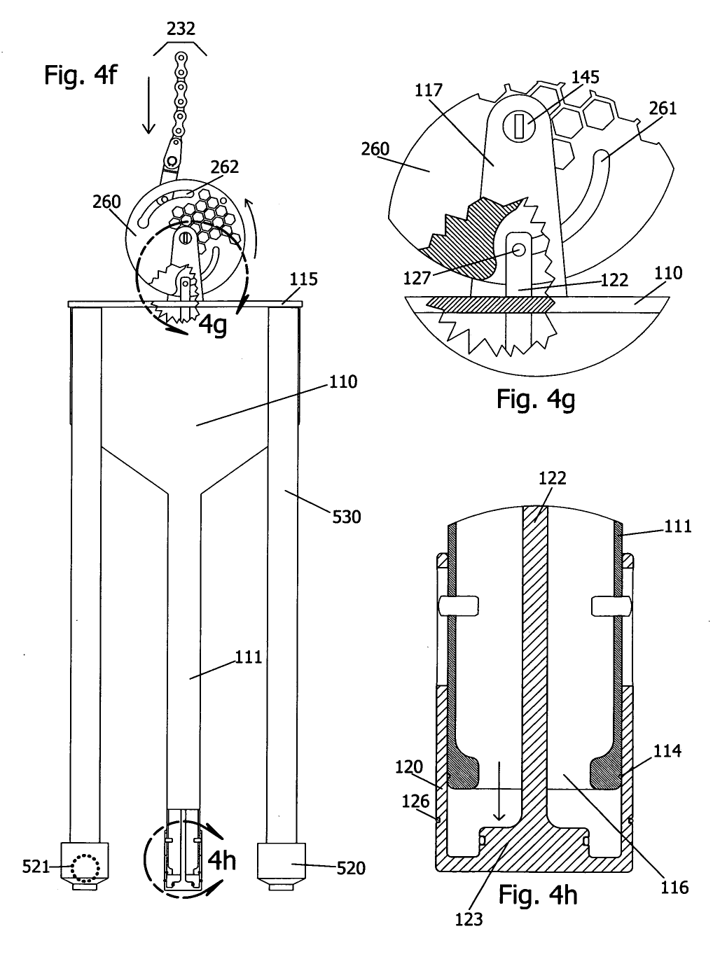

FIG. 4a shows a perspective view with certain components cut away to view specific inner components while in the entering position of the hanging stage of the slip bucket cycle.

FIGS. 4b & 4c show a perspective view of the slip bucket assembly in the fully hung/filling stage of the slip bucket cycle.

FIGS. 4d & 4e show a perspective view with certain components cut away to view the releasing stage of the slip bucket cycle.

FIGS. 4f, 4g & 4h show a front view of the slip bucket assembly as it reaches the opening stage of the slip bucket cycle.

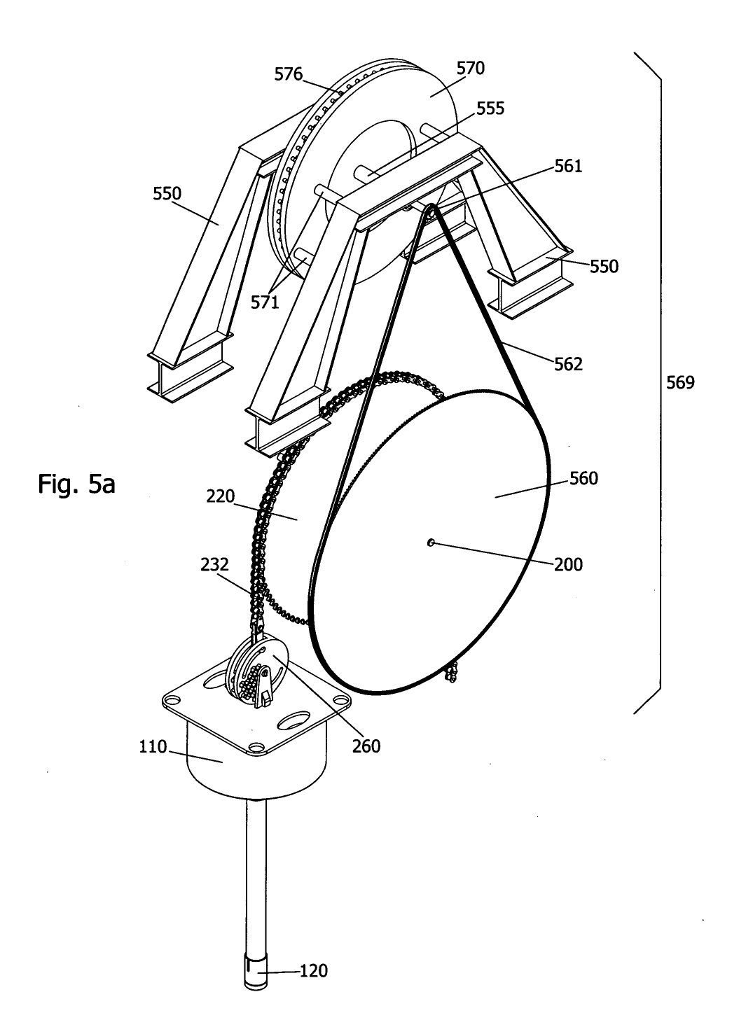

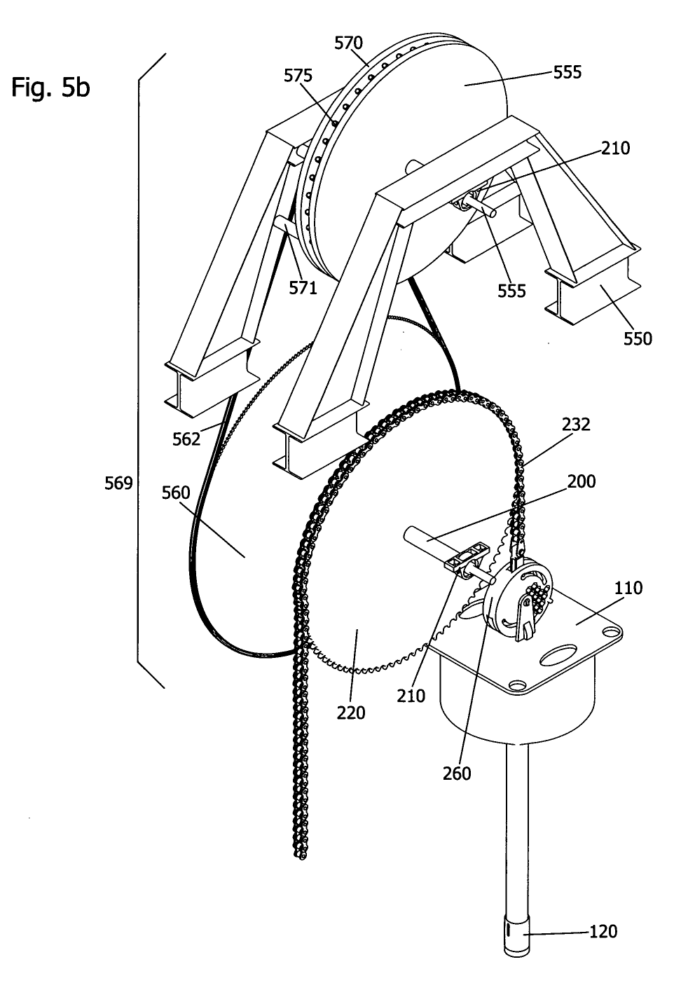

FIG. 5a shows a perspective front view of the general flywheel transmission assembly.

FIG. 5b shows a perspective rear view of the general flywheel transmission assembly.

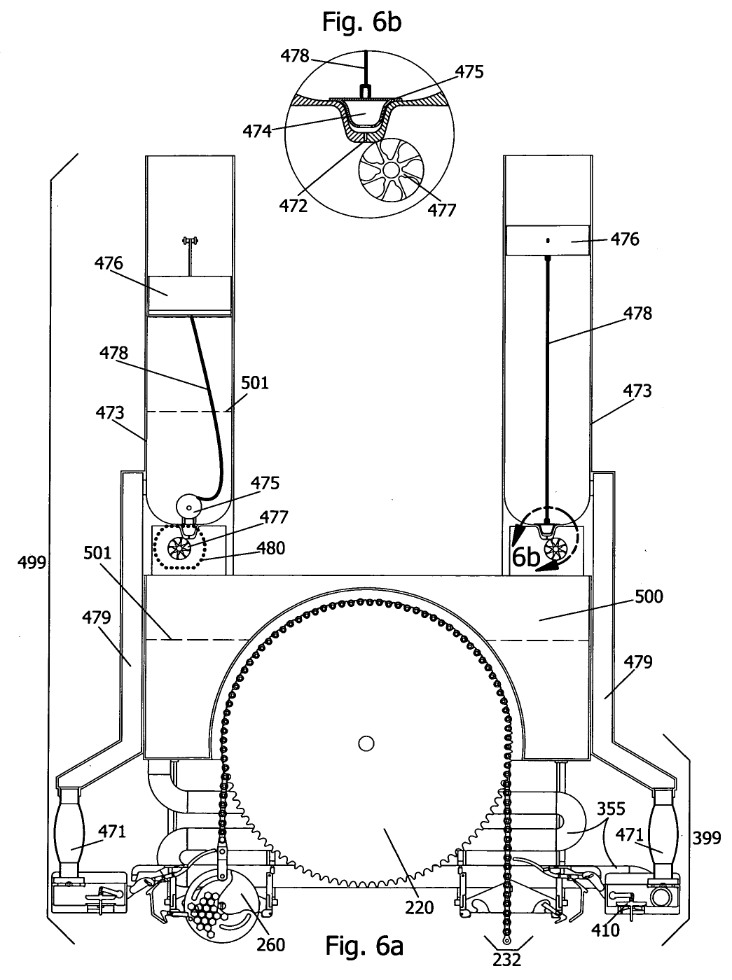

FIGS. 6a & 6b show a front cutaway view of the secondary ram pump cycle.

### DETAILED DESCRIPTION OF THE PREFERRED EMBODIMENTS

Detailed descriptions of the preferred embodiment are provided herein. It is to be understood, however, that the present invention may be embodied in various forms, compounded or stacked in unison. Structural framework and fastening such as nuts and bolts are purposely omitted to provide a better general concept of the invention. It is to be understood that lubrication and/or bearings are to be used in high friction areas. Therefore, specific details disclosed herein are not to be interpreted as limiting, but rather as a basis for the claims and as a representative basis for teaching one skilled in the art to employ the present invention in virtually any appropriately detailed system, structure or manner.

Referring to FIG. 1 there is shown a perspective view of a machine for Harvesting Energy from Gravity comprising a plural of slip bucket assemblies 199 each slip bucket assembly is generally comprised of a slip bucket sleeve 100 which houses a slip bucket piston 110 which is attached to a slip bucket piston valve 120 that reciprocates within the slip bucket sleeve 100. Further showing the main drive chain assembly 232 connecting the plural of slip bucket assemblies 199. The main drive chain assembly 232 connects an operator wheel 260 attached to each of the slip bucket pistons 110. A main tank 500 which houses the main body of fluid 501 for the invention. A fluid riser pipe assembly 535 to provide a means for the fluid 501 to be pumped back up to the main tank 500. Also showing a plural of fill up valve assemblies 399 that will provide a means to control the amount of fluid 501 deposited into the slip bucket piston 110. Also shown in FIG. 1 is the flywheel transmission assembly 569 comprising of a lower sprocket 560, a upper sprocket 561, and a flywheel transmission chain 562 allowing the flywheel transmission assembly 569 a geared ratio between the movement of the slip bucket assembly 199 and a flywheel and shaft 555. FIG. 1 further illustrates the secondary ram pump energy system 499 comprising of said fill up valve assembly 399 which also has a ram pump feature each time the valve is closed pushing fluid 501 into the fill up valve ram fluid run 470 to accumulate fluid 501 for the secondary ram pump energy system 499. FIG. 1 also shows the cross-sectional paths 10, 11, 12, 13, and 14 shown in some of the following figures.

FIG. 2a shows a left front view cut along the cross-sectional paths 10 and 11 shown in FIG. 1. This view shows inner components and one stage of a continuous slip bucket cycle. Referring to the slip bucket assembly 199 which is comprised of the fill up valve assembly 399, the slip bucket sleeve 100, the slip bucket piston 110, the slip bucket piston valve 120, and a fill up valve pipe assembly 355. Further showing a more detailed description of the slip bucket assembly 199 comprised of a fluid riser check valve 520, a fluid riser check valve ball 521, a fluid riser pipe (1a) 530, and a fluid riser pipe (1b) 540 of the fluid riser pipe assembly 535. Also showing the fluid 501 inside of the main tank 500 which is delivered by way of the fluid riser pipe assembly 535 on the return side of the slip bucket cycle and the fill up valve pipe assembly 355 on the fill up side of the slip bucket cycle. A slip bucket piston head 111 and a slip bucket piston body 112 of the slip bucket piston 110 fills with fluid 501 from the fill up valve pipe assembly 355 controlled by the fill up valve assembly 399. As the slip bucket piston body 112 fills with fluid 501 a slip bucket float 150 rises to release the slip bucket piston 110 from a slip bucket hanger 130 applying the weight of the fluid 501 held within the slip bucket piston 110 to the operator wheel 260 and the main drive chain assembly 232 turning a main drive sprocket 220 and a main drive shaft 200. The operator wheel 260 also controls a slip bucket valve rod 122 of the slip bucket piston valve 120 in the close-up view FIG. 2b which refers to a more detailed view of a slip bucket valve plug 123 which has a slip bucket valve inner o-ring 125 around its outer edge to form a seal within the slip bucket piston head 111 and the slip bucket piston valve 120 keeping the weight of the fluid 501 within the slip bucket piston 110. Also showing a slip bucket valve outer o-ring 126 within the outer perimeter of the slip bucket piston valve 120 to provide a seal between the slip bucket piston valve 120 and the slip bucket sleeve 100. The close-up view of FIG. 2b also shows the slip bucket valve pin 121 within the slip bucket valve pin guide 124 of the slip bucket piston valve 120 to provide a means of holding the slip bucket piston valve 120 in a slide able stage along the elongated axis of the slip bucket piston 110 allowing the slip bucket piston valve 120 to open or close without allowing the slip bucket piston valve 120 to turn.

FIG. 2c shows a perspective right front view cut along the cross-sectional paths 10 and 11 shown in FIG. 1, showing inner components and the opening stage of the slip bucket cycle. This is the opposite position of the slip bucket cycle shown in FIG. 2a. In this stage of the slip bucket cycle, the slip bucket piston 110 no longer is held by the slip bucket hanger 130 which now rests on the fluid riser pipe (1a) 530 stopped by a slip bucket piston top 115. Inertia from other components provide slack in the main drive chain assembly 232 by continuing to turn the main drive sprocket 220 and main drive shaft 200 allowing the heavy side of the operator wheel 260 to rotate forcing the slip bucket valve rod 122 to open the slip bucket piston valve 120. The close-up view of FIG. 2d shows in more detail an aperture 116 in the lower section of the slip bucket piston head 111, and a plural of apertures 128 in the lower section of the slip bucket valve 120 located around the slip bucket valve plug 123. The slip bucket piston 110 is now freed from the weight of the fluid 501 within the slip bucket piston 110, since that weight now rests on the bottom 101 of the slip bucket sleeve 100. There is also shown a slip bucket piston o-ring 114 in the slip bucket piston head 111 and a slip bucket valve outer o-ring 126 in the slip bucket piston valve 120 to prevent the fluid 501 from leaking into the upper slip bucket sleeve 100. The fluid 501 that was previously in the upper slip bucket sleeve 100 is now displaced by the slip bucket piston 110 and is in the fluid riser pipe assembly 535 and rests on the fluid riser check valve ball 521 within the fluid riser check valve 520. Since the hydrostatic pressure of the fluid 501 column within the fluid riser pipe assembly 535 is greater than the hydrostatic pressure of the fluid 501 column within the slip bucket piston 110 the fluid riser check valve ball 521 seals against the fluid riser check valve 520 not allowing the fluid 501 column within the fluid riser pipe assembly 535 to fall and displace the fluid 501 column within slip bucket piston 110. Since the slip bucket piston valve 120 is now in the open position the slip bucket piston 110 only has its own weight, plus fluid friction to overcome on the upstroke of this slip bucket cycle. Therefore, the weight of the slip bucket piston 110 plus the amount of fluid 501 weight of the opposite side will fall from the force of gravity on the next stroke pulling this slip bucket piston 110 back into the fill stage of the slip bucket cycle.

FIG. 3a shows a more detailed perspective view of the primary fill up valve assembly 399 in the open fill stage cut along the cross-sectional path 10 shown in FIG. 1. This means fluid 501 from above would be flowing into the fill up valve body 400 in between a fill up valve 410 and a fill up valve seat 402 into an aperture 401 in the lower fill up valve body 400. The fill up valve 410 is held open by a fill up valve link 420 attached to the secondary fill up valve lever arm 354 this allows the fluid to flow into the fill up valve bottom 440 and into the slip bucket piston 110 shown in FIG. 2a. The secondary fill up valve lever arm 354 is part of the secondary fill up valve lever assembly 352 that uses the movement of the operator wheel 260 to open the fill up valve 410 through leverage. The operator wheel 260 lifts a primary fill up valve lever 300 pivoting on a primary fill up valve lever fulcrum point 302 causing a primary fill up valve lever clasp 343 and the primary fill up valve lever clasp receiver 301 to become interlocked. The primary fill up valve lever clasp 343 is on a primary fill up valve lever catch (b) 341 which pivots on a primary fill up valve lever catch fulcrum point 344. The fill up valve lever hinge 310 is held rigid along with the primary fill up valve lever 300 via a fill up valve lever hinge lock catch tooth 321 on a fill up valve lever hinge lock 320. Therefore, when the primary fill up valve lever 300 is lifted and locked into place, the operator wheel 260 has pushed the primary fill up valve lever 300 attached to the fill up valve lever hinge 310 lowering one side of the secondary fill up valve lever assembly 352 making a fulcrum point at a secondary fill up valve lever pin 311 inside a secondary fill up valve lever pin groove 353 in one side of the secondary fill up valve lever assembly 352. This lifts the secondary fill up valve lever arm 354, the fill up valve link 420 and the fill up valve 410 opening the fill up valve assembly 399. FIG. 3a further shows in more detail view of the main drive chain assembly 232 comprising a drive chain inner link 230, a drive chain outer link 231, a main drive chain connector link 240, a main drive chain operator wheel link 250 and a main drive chain operator wheel link pin 251. The main drive chain operator wheel link pin 251 is located within a main drive chain assembly controller groove 262 in the operator wheel 260. At this stage of the slip bucket cycle the operator wheel 260 is rotated so that a plural of slip bucket valve arms 127 inside of a slip bucket valve controller groove 261 forces the slip bucket valve rod 122 to close the slip bucket piston valve 120 shown in FIG. 2a. In this stage of the slip bucket cycle an operator wheel guide arm 263 on the lighter side of the operator wheel 260 is positioned to push a fill up valve lever hinge lock release 330 downward. The fill up valve lever hinge lock release 330 is held in place on a fill up valve lever hinge lock release fulcrum point 331 within a fill up valve lever hinge lock release fulcrum groove 333 by a pull spring 332 which pulls on the lower section of the fill up valve lever hinge lock release 330 keeping it ready to release the fill up valve lever hinge lock 320 via a fill up valve lever hinge lock arm 322. Also showing a perspective view of a fill up valve ram check plate 460 further explained in FIG. 3b.

FIG. 3b shows a front view cut along the cross-sectional path 10 shown in FIG. 1. A more detailed view of the fill up valve assembly 399 shows that the operator wheel 260 is no longer held up by the slip bucket hanger 130 and is now suspended by the main drive chain assembly 232. The operator wheel guide arm 263 now moves downward with the operator wheel 260 pushing against a pull spring 332 on the lower side of a fill up valve lever hinge lock release 330. The fill up valve lever hinge lock release 330 pivots within the fill up valve lever hinge lock release fulcrum groove 333 on the fill up valve lever hinge lock release fulcrum point 331. The fill up valve lever hinge lock release 330 now pushes the fill up valve lever hinge lock arm 322, releasing the fill up valve lever hinge lock catch tooth 321 on the fill up valve lever hinge lock 320 shown in the close-up view of FIG. 3c. This releases the fill up valve lever hinge 310 from being held ridged with the primary fill up valve lever 300 at the fill up valve lever hinge fulcrum point 303 allowing the fill up valve lever hinge 310 to pivot upward. This now allows the secondary fill up valve lever assembly 352 to pivot on its fulcrum, further allowing the secondary fill up valve lever arm 354 to close the gap between the fill up valve 410 and the fill up valve seat 402 of the fill up valve body 400. When the secondary fill up valve lever assembly 352 pivots on its fulcrum to close the fill up valve 410, the secondary fill up valve lever head 357 moves upward separating the primary fill up valve lever catch (b) 341 and the primary fill up valve lever catch (a) 340 (shown in FIG. 3d) forcing said primary fill up valve lever catch (a) 340 and primary fill up valve lever catch (b) 341 to pivot at a primary fill up valve lever catch fulcrum point 344 releasing the primary fill up valve lever clasp 343 from the primary fill up valve lever clasp receiver 301 allowing the primary fill up valve lever 300 to fall, resetting the fill up valve assembly's 399 lever mechanisms. When the fill up valve 410 closes the fluid 501 flowing into the fill up valve body 400 is compressed. This forces the fluid 501 through an aperture 462 in the upper fill up valve body 400 and in between the seal of the fill up valve ram check plate 460 and a fill up valve ram check plate seat 403 allowing the fluid 501 into the fill up valve ram damper 471 affixed to a fill up valve top 430 causing a ram affect from the fluid 501 column above the fill up valve 410 being compressed.

FIG. 3d shows a perspective view of certain components of the fill up valve assembly 399 in the closed ram stage. The fill up valve body 400 is cut along the cross-sectional path 10 and the slip bucket hanger brace 135 is cut along the cross-sectional path 14 shown in FIG. 1, to more easily view the aperture 356 and a plural of apertures 462 in said fill up valve body 400. Also showing a better view of the fill up valve ram check plate seat 403, the secondary fill up valve lever arm 354, and the fill up valve 410. FIG. 3e shows the close-up view of the primary fill up valve lever clasp receiver 301 on the primary fill up valve lever 300 and the primary fill up valve lever clasp 343 of both the primary fill up valve lever catch (a) 340 and the primary fill up valve lever catch (b) 341 which pivot at the primary fill up valve lever catch fulcrum point 344 on the slip bucket hanger brace 135. So when the secondary fill up valve lever head 357 (shown in FIG. 3b) of the secondary fill up valve lever assembly 352 rose to separate the primary fill up valve lever catch (a) 340 and the primary fill up valve lever catch (b) 341, it released the primary fill up valve lever clasp 343 from the primary fill up valve lever clasp receiver 301 allowing the primary fill up valve lever 300 to drop. Thus when the operator wheel 260 (shown in FIG. 3b) moves completely out of the way, the fill up valve lever hinge lock catch tooth 321 of the fill up valve lever hinge lock 320 locks the primary fill up valve lever 300 and the fill up valve lever hinge 310 making them rigid again. Further shown in FIG. 3d, a more detailed view of the slip bucket hanger brace 135 with a plural of cut-outs 134 located in the general lower mid section of said slip bucket hanger brace 135. A plural of slip bucket hangers 130 with a slip bucket hanger push spring 129 placed in each of the cut-outs 134 in slip bucket hanger brace 135 to hold said plural of slip bucket hangers 130 in place against the inner wall of each cut-out 134 in the slip bucket hanger brace 135. Also showing a slip bucket catch bar receiver 133, a plural of slip bucket hanger guide grooves 131, and a plural slip bucket hanger arms 132 on each slip bucket hanger 130. FIG. 3e also shows a leaf spring 345 in between the primary fill up valve lever catch (a) 340 and the primary fill up valve lever catch (b) 341 at the primary fill up valve lever clasp 343 section to push the primary fill up valve lever clasp 343 outward.

FIG. 4a shows a perspective view with the slip bucket piston 110 cut along the cross-sectional path 12 and one of the slip bucket hangers 130 cut along the cross-sectional path 13 (shown in FIG. 1), to view specific inner components while in the entering position of the hanging stage of the slip bucket cycle. The opposite slip bucket assembly 199 also shown in FIG. 1, pulls the main drive chain assembly 232 with the main drive chain operator wheel link pin 251 in the main drive chain assembly controller groove 262. Since the slip bucket assembly 199 is in the up stroke the heavy side of the operator wheel 260 has rotated downward forcing the slip bucket valve rod 122 to open the slip bucket valve 120 shown in FIG. 2d. In this figure however the slip bucket assembly 199 is nearing the end of the up stroke and a spring loaded slip bucket catch bar 140 within a slip bucket catch bar case 145 is moving up with the slip bucket piston 110 towards a slip bucket catch bar receiver 133 cut in each of the slip bucket hangers 130. The plural of slip bucket hangers 130 is held in place by a plural of slip bucket hanger push springs 129 in each cutout 134 in the slip bucket hanger brace 135. The slip bucket catch bar case 145 maintains rotational axes for the operator wheel 260 while also lifting a plural of pad eyes 117 located on each side of the operator wheel 260 and affixed to the top 115 of the slip bucket piston 110. As the main drive chain assembly 232 pulls the slip bucket assembly 199 up through the plural of slip bucket hangers 130 the operator wheel guide arm 263 goes into the slip bucket hanger guide groove 131 forcing the operator wheel 260 to rotate in the opposite direction from what the heavy side of the operator wheel 260 had rotated it earlier. This forces the main drive chain operator wheel link pin 251 to move in the main drive chain assembly controller groove 262 while also forcing the plural of slip bucket valve arms 127 (shown in FIG. 3a) to move in the slip bucket valve controller groove 261. This also forces the slip bucket valve rod 122 to close the slip bucket valve 120 (shown in FIG. 2a) allowing more fluid 501 to be put in the slip bucket assembly 199. FIG. 4a also shows a slip bucket float 150 inside a slip bucket piston body 112, a plural of slip bucket piston guides 113 located on each corner of the slip bucket piston top 115, and a plural of slip bucket hanger arms 132 located on each end of the slip bucket hangers 130. FIG. 4a also shows an aperture 118 in slip bucket piston top 117 to allow the slip bucket piston 110 to be refilled.

FIG. 4b shows a perspective view of the slip bucket assembly 199 in the fully hung/filling stage of the slip bucket cycle. The slip bucket piston 110 is cut along the cross-sectional path 12 and one of the slip bucket hangers 130 is cut along the cross-sectional path 13 (shown in FIG. 1). A more detailed view is shown in the dose-up view of FIG. 4c. This stage of the slip bucket cycle allows the slip bucket assembly 199 to be supported at the slip bucket catch bar receiver 133 cut in the slip bucket hanger 130. A plural of spring loaded slip bucket catch bars 140 located in each side of the slip bucket catch bar case 145 push into the opening of the slip bucket catch bar receiver 133. The slip bucket catch bar case 145 is affixed to the pad eyes 117 on the top 115 of the slip bucket piston 110 and holds the slip bucket assembly 199 at the spring loaded slip bucket catch bars 140 within the slip bucket catch bar receiver 133. Each of the slip bucket hangers 130 is held up by the plural of slip bucket hanger arms 132 moveably placed in the plural of cutouts 134 in each slip bucket hanger brace 135 with a plural of slip bucket hanger push spring 129 holding each slip bucket hanger 130 upright the slip bucket hanger 130 supports the slip bucket piston 110. While the slip bucket assembly 199 is held in place and the slip bucket valve 120 is closed the fill up valve assembly 399 is open, allowing this slip bucket assembly 199 to be filled with fluid 501 again. As this slip bucket piston head 111 and the slip bucket piston body 112 of the slip bucket piston 110 fill with fluid 501 from the fill up valve bottom 440 of the fill up valve assembly 399 (shown in FIGS. 2 & 3) through a fluid access area 152 of the slip bucket float 150 and a aperture 118 in the slip bucket piston top 115, the slip bucket float 150 will rise due to bouncy. This will then lift a plural of slip bucket hanger wedges 151 affixed to the top of the slip bucket float 150 on the outside of each pad eye 117 on the slip bucket piston top 115.

FIG. 4d shows a perspective view with certain components cut away to view the releasing stage of the slip bucket cycle. The slip bucket piston 110 is cut along the cross-sectional path 12 and one of the slip bucket hangers 130 is cut along the cross-sectional path 13 (shown in FIG. 1). As the fluid 501 in the slip bucket piston 110 pushes the slip bucket float 150 up, the slip bucket hanger wedge 151 (shown in more detail in the close-up view of FIG. 4e) wedges between the slip bucket hanger 130 and the pad eyes 117 on each slide of the slip bucket piston top 115. Therefore the plural of the slip bucket catch bar receiver 133 on each slip bucket hanger 130 is pulled away from each spring loaded slip bucket catch bar 140 allowing the slip bucket piston 110 to fall due to the weight of the fluid 501 held within the slip bucket piston 110.

FIG. 4f shows a front view of the slip bucket piston 110 as it reaches the opening stage of the slip bucket cycle. The close-up view of FIG. 4g shows a breakaway view of the slip bucket piston 110 revealing the plural of slip bucket valve arms 127 affixed to the slip bucket valve rod 122. The plural of slip bucket valve arms 127 moves in the slip bucket valve controller groove 261 in the operator wheel 260 as the slip bucket piston top 115 stops on top of the fluid riser pipe (1a) 530. The heavy side of the operator wheel 260 forces the operator wheel 260 to rotate on the slip bucket catch bar case 145 in the direction that opens the slip bucket piston valve 120 by pushing the plural of slip bucket valve arms 127 on the slip bucket valve rod 122 within the slip bucket valve controller groove 261. The close-up view of FIG. 4h shows a cutaway view of the slip bucket piston valve 120 and the slip bucket piston head 111 revealing the slip bucket valve rod 122 of the slip bucket piston valve 120. The slip bucket valve plug 123 is removed from the aperture 116 in lower slip bucket piston head 111 allowing the fluid 501 to flow out of the slip bucket piston 110 as it rises in the next stage of the slip bucket cycle.

FIG. 5a shows a perspective front view of the flywheel transmission assembly 569. Which is generally comprised of a lower sprocket 560, an upper sprocket 561, and a flywheel transmission chain 562 connecting said lower sprocket 560 and said upper sprocket 561. The upper sprocket 561 is connected to a flywheel and shaft 555 which rotates at a different speed due to the turning ratio of the lower sprocket 560 and said upper sprocket 561. The lower sprocket 560 is connected to a main drive shaft 200 which is turned by the weight of the fluid 501 in the slip bucket piston 110 sealed off at the slip bucket piston valve 120. The operator wheel 260 affixed to the slip bucket piston 110 pulls the main drive chain assembly 232 wrapped around the main drive sprocket 220 that is affixed to the main drive shaft 200 producing the rotational torque that drives the flywheel transmission assembly 569. The flywheel and shaft 555 is held in place by a plural of flywheel braces 550 that also provides a means to mount a plural of magnetic coil bracket mounts 571 affixed to a magnetic coil mounting bracket 570. FIG. 5a also shows a plural of permanent magnets 576 mounted within the outer rotational perimeter of the flywheel and shaft 555.

FIG. 5b shows a perspective rear view of the general flywheel transmission assembly 569, comprising a plural of pillow blocks 210 that allow the main drive shaft 200 and flywheel and shaft 555 to rotate around an axis while also holding said main drive shaft 200 and flywheel and shaft 555 in place. That allows the weight of the fluid 501 held in the slip bucket piston 110 by the slip bucket piston valve 120 to be converted into energy which pulls the operator wheel 260 and the main drive chain assembly 232 rotating the main drive sprocket 220. The main drive sprocket 220 is affixed to the main drive shaft 200 which drives the lower sprocket 560 therefore driving the flywheel transmission assembly 569. FIG. 5b further shows a plural of electronic magnetic coils 575 mounted within the outer perimeter of the magnetic coil mounting bracket 570. As the weight of the fluid 501 held in the slip bucket piston 110 by the slip bucket piston valve 120 is converted into energy it drives the flywheel transmission assembly 569 to rotate the flywheel and shaft 555 with the plural of permanent magnets 576 (shown in FIG. 5a). The plural of permanent magnets 576 pass near the plural of electronic magnetic coils 575 mounted on the magnetic coil mounting bracket 570 generating electricity.

FIG. 6a shows a front cutaway view of a secondary ram pump energy system 499 cut along the cross-sectional paths 10 (shown in FIG. 1). Each time one of the fill up valve assembly 399 is closed during the slip bucket cycle the fluid 501 in the corresponding fill up valve pipe assembly 355 continues to move compressing the fluid 501 in the fill up valve assembly 399. The pressure of the fluid 501 in the fill up valve assembly 399 then overcomes the hydrostatic pressure in the fill up valve ram damper 471 allowing fluid 501 into the fill up valve ram damper 471. The fill up valve ram damper 471 accepts fluid 501 to be hydrostatically balanced into a secondary ram pump energy system 499. The fill up valve ram damper 471 is made with a pliable material such as rubber so it can absorb the energy from the moving fluid 501 inside the fill up valve pipe assembly 355 and the main tank 500 when the fill up valve assembly 399 is closed. The repercussions absorbed by the fill up valve ram damper 471 can now hydrostatically equalize throughout a ram fluid travel tube 479 and a ram fluid holding tank 473 accumulating fluid 501 in said ram fluid holding tank 473. The fluid 501 increases in the ram fluid holding tank 473 until a ram fluid release valve float 476 pulls a ram fluid release cable 478 lifting a ram fluid release valve 475 shown in more detail in the close-up view of FIG. 6b. The fluid 501 rushes out of a ram fluid jet 472 at the bottom of the ram fluid holding tank 473 under the ram fluid release valve 475 turning a ram fluid generator wheel 477 on the electric generator 480 producing electricity. The fluid 501 then falls back into the main tank 500 for another cycle through either the slip bucket cycle or the secondary ram pump energy system 499. As the fluid 501 drains from the ram fluid holding tank 473 the ram fluid release valve float 476 swings downward allowing the ram fluid release cable 478 to become slack. Air inside a ram fluid release valve air trap 474 holds the ram fluid release valve 475 open for the rest of the fluid 501 in the ram fluid holding tank 473 to drain. Gravity then closes the ram fluid release valve 475 when the ram fluid holding tank 473 is empty.

FIGS. 6a & 2c further shows the way said fill up valve pipe assembly 355 allows the fluid 501 to flow from the main tank 500 into the fill up valve assembly 399 providing an elongated fluid 501 column to amplify a ram effect when the fill up valve assembly 399 closes.

### OPERATION OF THE PREFERRED EMBODIMENT

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for harvesting energy from gravity comprising:
a fluid filled main tank located at an elevated height comprised of a plural of slip bucket assemblies, a plural of fill up valve assemblies, a flywheel transmission assembly, and a secondary ram pump energy system.

2. A machine for harvesting energy from gravity as described in claim 1, comprising
a plural of slip bucket assemblies each comprised of:
a generally elongated and winding fill up valve pipe assembly attached to the bottom of said main tank;
a fill up valve assembly to control the release of fluid from said fill up valve pipe assembly; and
a slip bucket piston with an aperture in the lower end, the lower end is considerably smaller than its larger top section, designed to hold fluid from said fill up valve assembly; and
a slip bucket valve located around the lower section of the slip bucket piston; and
a operator wheel being heavier on one side with a plural of channels cut into the circumference of the lighter side of said operator wheel and an aperture through said operator wheel's center; and
a plural of slip bucket hangers with a slip bucket hanger guide groove in the outer edge used to rotate said operator wheel and a slip bucket catch bar receiver in the top mid section of said slip bucket hangers which is used to hold said slip bucket piston while it is filling with fluid; and
a plural of slip bucket hanger braces to provide a means for holding said slip bucket hangers and said fill up valve assembly in place; and
a slip bucket sleeve with a hollowed center throughout and a plural of apertures in the bottom section that provide a means for said slip bucket valve and said slip bucket piston to displace fluid back up to said main tank; and
a plural of fluid riser pipe assemblies used to transfer fluid from said plural of apertures in the bottom of said slip bucket sleeve to said main tank; and
a slip bucket float that is buoyant with a plural of slip bucket hanger wedges located the top of said slip bucket float, said slip bucket float is located inside the larger top section of said slip bucket piston and used to release said slip bucket piston from said plural of slip bucket hangers; and
a spring loaded slip bucket catch bar within a slip bucket catch bar case located in the aperture through the center of said operator wheel and designed hold up said slip bucket piston while in the fill up stage of the slip bucket cycle.

3. A machine for harvesting energy from gravity as described in claim 2, comprised
of said plural of fill up valve assemblies each comprised of:
a fill up valve body with a fill up valve top having a fill up valve bottom used to fill said slip bucket piston;
a fill up valve and a fill up valve seat used to stop fluid from flowing into said fill up valve bottom; and
a primary fill up valve lever clasp receiver on the upper mid section of a generally elongated shaped primary fill up valve lever with a primary fill up valve lever fulcrum point located in the general mid section of said primary fill up valve lever to provide leverage to open said fill up valve; and
a fill up valve lever hinge with a fill up valve lever hinge fulcrum point located at one end of said fill up valve lever hinge; and
a fill up valve lever hinge lock arm on a fill up valve lever hinge lock with a fill up valve lever hinge lock catch tooth used to lock said fill up valve lever hinge and said primary fill up valve lever rigidly; and
a fill up valve lever hinge lock release used to push said fill up valve lever hinge lock arm, releasing said fill up valve lever hinge lock catch tooth unlocking said fill up valve lever hinge and said primary fill up valve lever; and
a leaf spring in between a plural of primary fill up valve lever catches with a primary fill up valve lever clasp and a primary fill up valve lever catch fulcrum point to provide a means to hold said primary fill up valve lever at said primary fill up valve lever clasp receiver on said primary fill up valve lever fulcrum point; and
a secondary fill up valve lever assembly with a secondary fill up valve lever pin in a secondary fill up valve lever pin groove on a secondary fill up valve lever head on one side of said secondary fill up valve lever assembly and a secondary fill up valve lever arm on the opposite said secondary fill up valve lever assembly to provide a means to open said fill up valve with leverage.

4. A machine for harvesting energy from gravity as described in claim 2, comprising
said slip bucket valve further comprising:
a slip bucket valve rod extending upright through the center of said slip bucket piston on top of a slip bucket valve plug designed to plug said aperture in the lower section of said slip bucket piston; and
a plural of slip bucket valve arms at the top of said slip bucket valve rod used to control said slip bucket valve; and
a plural of apertures in lower slip bucket valve in between said slip bucket valve plug and the outer wall of said slip bucket valve to allow fluid out of said slip bucket piston.

5. A machine for harvesting energy from gravity as described in claim 2, comprised
of said operator wheel further comprising:
a generally arch shaped slip bucket valve controller groove located on the lower portion of a channel cut into the circumference of the lighter side of said operator wheel with one side of said slip bucket controller groove being closer to the center of the operator wheel;
a generally arch shaped main drive chain assembly controller groove concentrically located in the upper portion of the channel cut into the circumference of the lighter side of said operator wheel; and
a cylindrically shaped operator wheel guide arm passing completely through and protruding from both sides of the lighter side of said operator wheel.

6. A machine for harvesting energy from gravity as described in claim 2, comprised
of said slip bucket hanger brace further comprising:
a plural of cutouts in said slip bucket hanger brace, said primary fill up valve lever fulcrum point, said fill up valve lever hinge lock release fulcrum point, said primary fill up valve lever catch fulcrum point and a plural of slip bucket hanger push spring located in said cutouts in said slip bucket hanger brace.

7. A machine for harvesting energy from gravity as described in claim 2, comprising
a plural of said slip bucket hangers each comprised of:
a slip bucket hanger guide groove used to guide said operator wheel guide arm making said operator wheel rotate, closing said slip bucket valve;
a plural of slip bucket hanger arms, one located on each side of said slip bucket hanger and designed to hold each slip bucket hanger up within said cutouts in said slip bucket hanger brace; and
a slip bucket catch bar receiver designed to retain said spring loaded slip bucket catch bar while allowing said slip bucket hanger to release said spring loaded slip bucket catch bar when said slip bucket hanger wedge moves up.

8. A machine for harvesting energy from gravity as described in claim 2, comprised
of said fluid riser pipe assembly further comprising:
a plural of fluid riser check valve balls within a plural of fluid riser check valves affixed to said plural of apertures in the bottom section of said slip bucket sleeve;
a plural of fluid riser pipes affixed to said fluid riser check valve to provide a means to move fluid from the bottom of said slip bucket sleeve back to said main tank.

9. A machine for harvesting energy from gravity as described in claim 1, comprised.
of a flywheel transmission assembly further comprising:
a main drive sprocket on a main drive shaft located over said slip bucket assembly with a main drive chain assembly running across the top of said main drive sprocket to provide a means for said slip bucket assembly to reciprocate within the slip bucket cycle;
a lower sprocket and an upper sprocket with a flywheel transmission chain to provide an adjustable turning ratio between said main drive shaft and said upper sprocket; and
a flywheel and a shaft located on a flywheel brace over said main tank and affixed to said upper sprocket; and
an electro-magnetic coil mounting bracket with a plural of electro-magnetic coils mounted around the perimeter of said magnetic coil mounting bracket and a plural of permanent magnets mounted around the perimeter of said flywheel to provide a means for creating electricity from gravity; and

10. A machine for harvesting energy from gravity as described in claim 1, comprised
of said secondary ram pump energy system further comprising:
a fill up valve ram check plate located just under a fill up valve ram damper affixed to said fill up valve top within said fill up valve assembly;
a ram fluid travel tube affixed to said fill up valve ram damper and leading up to a ram fluid holding tank with a ram fluid release valve float located in the upper most section of said ram fluid holding tank; and
a ram fluid release cable affixed to said ram fluid release valve float and a ram fluid release valve with a ram fluid release valve air trap to provide a means for the fluid to open said ram fluid release valve and air to hold it open until the said ram fluid holding tank is empty allowing the fluid to flow through a ram fluid jet across ram fluid generator wheel turning an electric generator.
